(19) United States
(12) Patent Application Publication
(10) Pub. No.: US 2025/0103805 A1
(43) Pub. Date: Mar. 27, 2025

(54) IMAGE PROCESSING APPARATUS, IMAGE PROCESSING METHOD, PROGRAM, AND RECORDING MEDIUM

(71) Applicant: FUJIFILM Corporation, Tokyo (JP)

(72) Inventors: Toshiki KOBAYASHI, Saitama-shi (JP); Kei YAMAJI, Saitama-shi (JP); Yuya NISHIO, Saitama-shi (JP); Kazuya OKIYAMA, Saitama-shi (JP)

(73) Assignee: FUJIFILM Corporation, Tokyo (JP)

(21) Appl. No.: 18/813,681

(22) Filed: Aug. 23, 2024

(30) Foreign Application Priority Data
Sep. 26, 2023 (JP) 2023-163760

(51) Int. Cl. G06F 40/253; G06F 40/166; G06V 10/40; G06V 10/774; G06V 10/776

(52) U.S. Cl. CPC G06F 40/253; G06F 40/166; G06V 10/40; G06V 10/774; G06V 10/776

(57) ABSTRACT

Provided are an image processing apparatus, an image processing method, a program, and a recording medium capable of assigning appropriate text information to an image.

An image processing apparatus according to one embodiment of the present invention includes a processor, in which the processor is configured to decide a text style based on an image and generate text information corresponding to the image based on the image and the text style.

### CROSS-REFERENCE TO RELATED APPLICATIONS

The present application claims priority under 35 U.S.C. § 119 to Japanese Patent Application No. 2023-163760, filed on Sep. 26, 2023. The above application is hereby expressly incorporated by reference, in its entirety, into the present application.

### BACKGROUND OF THE INVENTION

### 1. Field of the Invention

One embodiment of the present invention relates to an image processing apparatus, an image processing method, a program, and a recording medium.

### 2. Description of the Related Art

As a technique of using an image, a technique of assigning a text to the image is already known, and an example thereof includes the technique disclosed in JP2019-149709A.

In the technique disclosed in JP2019-149709A, image data is analyzed to extract a keyword, and a decorative text that decorates the image data is decided based on the keyword. More specifically, the decorative text corresponding to the extracted keyword is searched with reference to a decorative text database in which the keyword and the decorative text are associated with each other to decide the decorative text. Accordingly, it is possible to perform a tasteful decoration without spending time and effort.

### SUMMARY OF THE INVENTION

In the technique disclosed in JP2019-149709A, text information (decorative text) is limited to text information determined in advance corresponding to the keyword in a case where the keyword is determined. However, even in a case where an appropriate keyword corresponding to the image is extracted, the text information determined in advance corresponding to the keyword may not correspond to appropriate text information corresponding to the image depending on the image. In this case, the appropriate text information is not assigned to the image.

One embodiment of the present invention has been made in view of the above circumstances, and an object thereof is to provide an image processing apparatus, an image processing method, a program, and a recording medium capable of assigning appropriate text information to an image.

The above object is achieved by an image processing apparatus according to any one of [1] to [19].
[1] An image processing apparatus comprising a processor, in which the processor is configured to decide a text style based on an image, and generate text information corresponding to the image based on the image and the text style.
[2] The image processing apparatus according to [1], in which the processor is configured to set a first decision mode in which the text style is decided based on the image or a second decision mode in which the text style is decided based on first input information, and decide the text style based on the set first decision mode or second decision mode.
[3] The image processing apparatus according to [1] or [2], in which the processor is configured to decide, in a case where the second decision mode is set, the text style based on the first input information from a user related to the text style.
[4] The image processing apparatus according to any one of [1] to [3], in which the processor is configured to output the decided text style, decide the text style again based on second input information related to the text style, and generate the text information based on the image and the text style decided again.
[5] The image processing apparatus according to any one of [1] to [4], in which the processor is configured to decide the text style based on a specific subject region extracted by analyzing the image.
[6] The image processing apparatus according to any one of [1] to [5], in which the processor is configured to decide two or more text styles based on the image, and generate the text information based on the two or more text styles.
[7] The image processing apparatus according to any one of [1] to [6], in which the processor is configured to decide the two or more text styles having different themes based on the image, and generate, according to a combination of the two or more text styles having different themes, the text information for each combination.
[8] The image processing apparatus according to any one of [1] to [7], in which the processor is configured to use a first trained model trained to output the text information by inputting the image and the text style to generate the text information.
[9] The image processing apparatus according to any one of [1] to [8], in which the processor is configured to specify the text information corresponding to the input image and text style with reference to a first table in which a correspondence relationship between the image and the text style and the text information is set in advance.
[10] The image processing apparatus according to any one of [1] to [9], in which the processor is configured to use a second trained model trained to output the text style by inputting the image to decide the text style.
[11] The image processing apparatus according to any one of [1] to [10], in which the processor is configured to specify the text style corresponding to the input image with reference to a second table in which a correspondence relationship between the image and the text style is set in advance.
[12] The image processing apparatus according to any one of [1] to [11], in which the processor is configured to generate two or more candidates for the text information based on the image and the text style, output the generated two or more candidates for the text information, and decide the text information from the two or more candidates for the text information based on selection information by a user.
[13] The image processing apparatus according to any one of [1] to [12], in which the processor is configured to decide two or more text styles based on the image, assign an evaluation score according to a correlation with a content of the image to each of the two or more text styles, generate the text information for each text style to which the evaluation score is assigned based on the image and the text style, and output the generated two or more pieces of text information based on the evaluation score of the text style.
[14] The image processing apparatus according to any one of [1] to [13], in which the processor is configured to decide two or more text styles based on the image, assign an evaluation score according to a correlation with a content of the image to each of the two or more text styles, generate the text information based on the image and the text style having a highest evaluation score among the two or more text styles, output the generated text information, output, in a case where a request for generating the text information again is received, the text style different from the text style having the highest evaluation score, and generate the text information again based on the image and the text style selected by a user.
[15] The image processing apparatus according to any one of [1] to [14], in which the processor is configured to output the generated text information, and correct, in a case where third input information related to correction of the text information is received, the text information based on the third input information.
[16] The image processing apparatus according to any one of [1] to [15], in which the processor is configured to reconstruct a first trained model constructed by performing machine learning using learning data including an image, a text style, and text information, using the learning data including the corrected text information.
[17] The image processing apparatus according to any one of [1] to [16], in which the processor is configured to correct a first table in which a correspondence relationship between the image and the text style and the text information is set in advance, using the corrected text information.
[18] The image processing apparatus according to any one of [1] to [17], in which the processor is configured to acquire a plurality of the images, decide the text style common to the acquired plurality of images, and generate the text information common to each of the plurality of images based on the plurality of images and the common text style.
[19] The image processing apparatus according to any one of [1] to [18], in which the processor is configured to store at least one of the decided text style or the generated text information as corresponding accessory information of the image.

Further, the above object can be achieved by an image processing method described in [20] below.
[20] An image processing method executed by a processor, comprising processing of deciding a text style based on an image, and processing of generating text information corresponding to the image based on the image and the text style.

Further, a program according to one embodiment of the present invention is a program for causing a computer to execute each step included in the image processing method described in [20] above.

Further, a recording medium according to one embodiment of the present invention is a computer-readable recording medium on which a program for causing a computer to execute each step included in the image processing method described in [20] above is recorded.

According to one embodiment of the present invention, there are provided an image processing apparatus, an image processing method, a program, and a recording medium capable of assigning the appropriate text information to the image.

### BRIEF DESCRIPTION OF THE DRAWINGS

FIG. 1 is a diagram showing a use example of an image processing apparatus according to one embodiment of the present invention.

FIG. 2 is a diagram showing a procedure from acquisition of an input image to generation of text information.

FIG. 3 is a diagram showing a hardware configuration of the image processing apparatus according to one embodiment of the present invention.

FIG. 4 is a diagram for describing a function of the image processing apparatus according to one embodiment of the present invention.

FIG. 5 is a diagram showing an operation screen for text information generation according to one embodiment of the present invention.

FIG. 6 is a diagram showing an example of an image processing flow according to one embodiment of the present invention.

FIG. 7 is a diagram for describing a function of an image processing apparatus according to a first modification example of the present invention.

FIG. 8 is a diagram for describing a function of an image processing apparatus according to a second modification example of the present invention.

FIG. 9 is a diagram for describing a function of an image processing apparatus according to a third modification example of the present invention.

FIG. 10 is a diagram for describing a function of an image processing apparatus according to a fourth modification example of the present invention.

FIG. 11 is a diagram for describing an evaluation score for the fourth modification example of the present invention.

FIG. 12 is a diagram for describing a function of an image processing apparatus according to a fifth modification example of the present invention.

FIG. 13 is a diagram for describing a function of an image processing apparatus according to a sixth modification example of the present invention.

FIG. 14 is a diagram showing a procedure from acquisition of an input image to generation of text information for a seventh modification example of the present invention.

FIG. 15 is a diagram showing a procedure from acquisition of an input image to generation of text information for an eighth modification example of the present invention.

FIG. 16 is a diagram showing a procedure from acquisition of an input image to generation of text information in an image processing apparatus according to a comparative example.

### DESCRIPTION OF THE PREFERRED EMBODIMENTS

Hereinafter, specific embodiments of the present invention will be described.

In the following, for convenience of description, the description may be made in terms of a graphic user interface (GUI). Further, since basic data processing techniques (communication/transmission techniques, data acquisition techniques, data recording techniques, data processing/analysis techniques, machine learning techniques, image processing techniques, visualization techniques, and the like) for implementing the present invention are well-known techniques, the description thereof will be omitted.

Further, in the present specification, the concept of “apparatus” includes a single apparatus that exerts a specific function, and includes a combination of a plurality of apparatuses that exert a specific function in cooperation (coordination) with each other while being distributed and present independently of each other.

Further, in the present specification, a term “user” is a user of the image processing apparatus according to the embodiment of the present invention, and specifically, for example, a person who uses text information described below obtained by the function of the image processing apparatus according to the embodiment of the present invention.

Further, in the present specification, the term “person” means a main subject that performs specific behavior, may include an individual, a group, a corporation, such as a company, an organization, and the like, and may also further include a computer and a device that constitute artificial intelligence (AI). The artificial intelligence realizes intellectual functions, such as reasoning, prediction, and determination, by using a hardware resource and a software resource. An algorithm of the artificial intelligence is random, and examples thereof include an expert system, a case-based reasoning (CBR), a Bayesian network, or an inclusion architecture.

### One Embodiment of Present Invention

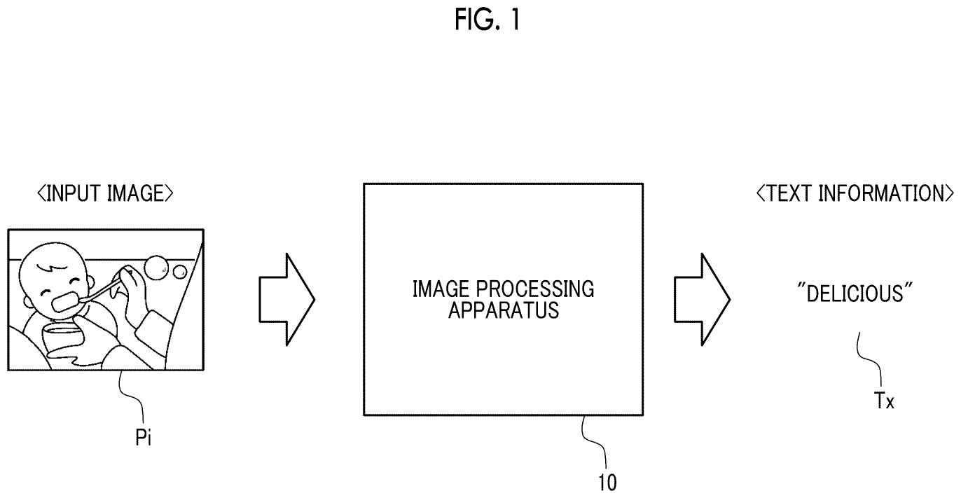

In one embodiment (hereinafter the present embodiment) of the present invention, the image processing apparatus (hereinafter image processing apparatus 10) generates the text information (hereinafter text information Tx) corresponding to an image (hereinafter input image Pi) input to the image processing apparatus 10 as shown in FIG. 1.

The user can assign the generated text information Tx to a desired position within the input image Pi or in the vicinity of the input image Pi. The assignment of the text information Tx is to generate an image (text object) indicating the text information Tx and combine the generated image with the input image Pi.

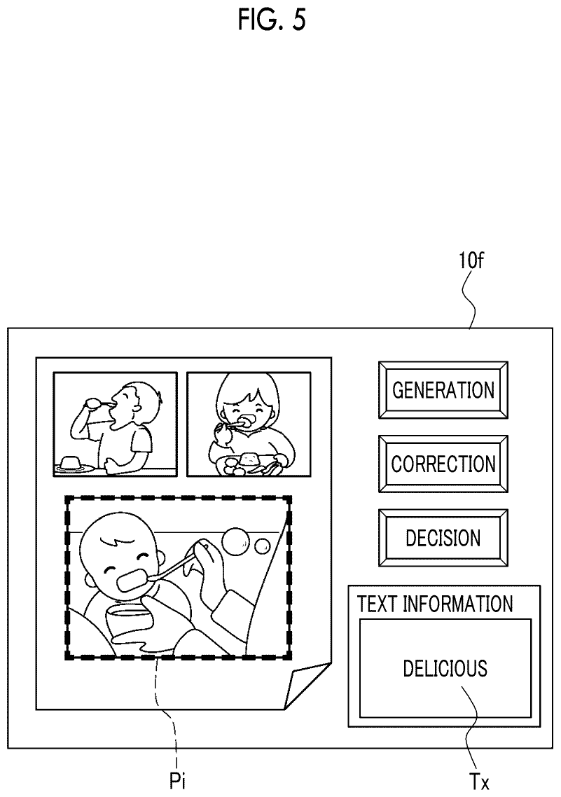

More specifically, an example of an operation screen for text information generation shown in FIG. 5 will be described. In the example shown in FIG. 5, first, the user selects the input image Pi showing “baby's meal scene”. Thereafter, the user clicks an icon (icon of “generation” in FIG. 5) for text information generation displayed on the screen. Accordingly, “delicious” is generated as the text information Tx in a field of the text information shown in a lower right of FIG. 5, as the text information Tx for describing the “baby's meal scene”. After the text information Tx is generated, the generated text information Tx is disposed within the input image Pi or in the vicinity of the input image Pi by a predetermined operation by the user. As described above, in the image processing apparatus 10, the generated text information Tx can be used by being assigned to the inside or the vicinity of the output image output on the screen.

The term “image” in the present invention is configured of a plurality of pixels, is expressed by a gradation value of each of the plurality of pixels, and includes at least one or more subjects. Further, digital image data (hereinafter image data) in which an image is defined at a set resolution is generated by compressing data in which the gradation value for each pixel is recorded by a predetermined compression method. Examples of a type of the image data include irreversible compressed image data, such as joint photographic experts group (JPEG) format, and reversible compressed image data, such as graphics interchange format (GIF) or portable network graphics (PNG) format.

In the present embodiment, a method of inputting the image is not particularly limited. For example, the method thereof includes inputting image data of the image captured by an imaging device such as a camera, and inputting reading data obtained by reading an existing photograph with a scanner or the like. Further, in a case where the imaging device is mounted on the image processing apparatus, the imaging device may capture the image and acquire the image data to input the image. Further, the image data may be downloaded from an external device, a web server, or the like via a communication network to input the image.

The term “input image Pi” may be a developed image obtained by developing a RAW image, a correction image subjected to predetermined correction processing on the developed image, or an edited image subjected to an editing process on the developed image or the correction image.

The edited image as the input image Pi may be an image configured by disposing one or a plurality of images in a predetermined layout. That is, the input image Pi may be an image including one or more image regions and a margin region other than the image regions. The image region includes the subject, and the margin region does not include the subject.

The term “text information Tx” is the text information corresponding to the input image Pi, that is, character information indicating a content according to the input image Pi. More specifically, the input image Pi is the character information indicating the content according to the subject in the input image Pi, which corresponds to, for example, a comment and a message to the subject, description of the subject, and a line uttered by the subject. The text information is configured of a phrase or a sentence consisting of one or more words. Further, the text information Tx may be the character information expressed by at least one of a font or a decoration decided by a text style St described below, or may be the character information fixed by a predetermined font and not including the decoration.

The term “subject” means a person, an animal, an object, a background, and the like included in the image. Further, the concept of the subject may include a place appearing in the image, a scene (for example, dawn or dusk and fine weather), and a theme (for example, an event such as a trip, a meal, or a sports day). The image may be a landscape image, that is, the subject included in the image may be only a landscape, and the entire image may represent the landscape as the subject.

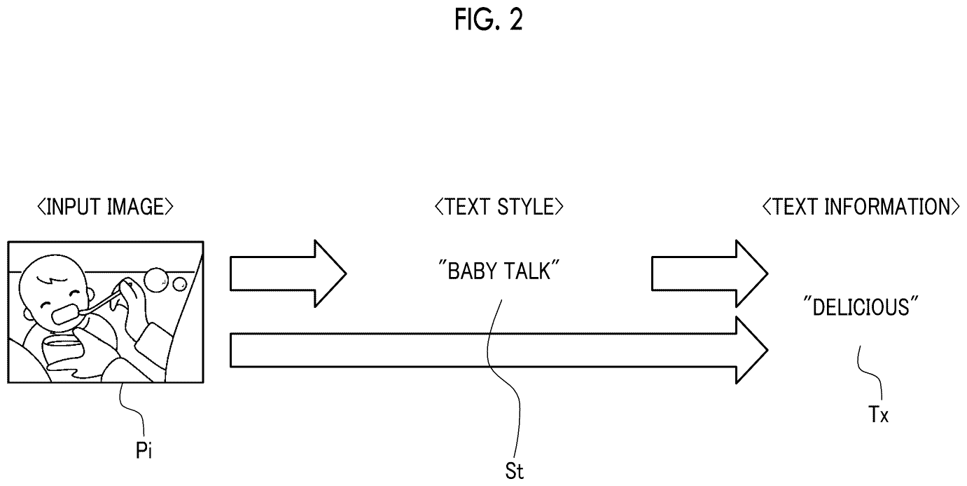

As shown in FIG. 2, the text information Tx is generated based on the input image Pi and the text style St, and the text style St is decided based on the input image Pi.

The term “text style St” means a style related to the expression of the text information Tx. The term “text style St” may include, for example, information such as an atmosphere, a writing style, a language system, an expression technique, a font, and a decoration.

The term “atmosphere” is, in a case where a scenery of the image or a state or situation of the subject in the image is expressed (texturized), an impression that is given by the expression or a feeling that may be felt from the expression, and may include, for example, “serious”, “pleasant”, and “lively”. The term “writing style” may include, for example, a colloquial style and a written style, and the term “colloquial style” may include, for example, a baby talk and a dialect. The term “language system” may include, for example, Japanese and English. The term “expression technique” may include, for example, an inversion method, onomatopoeia such as a mimetic word, and an interjection. The term “font” may include, for example, a European font such as a serif, and a handwritten font. The term “decoration” may include, for example, boldface, underlining, italics, and coloring.

Further, the text style St may be further limited or supplemented, for example, the text style St exemplified above. For example, the text style St may be “colloquial style popular with teenagers” by adding “popular with teenagers” indicating a line of sight, an aim, an intention, and the like, in contrast to “colloquial style” exemplified above.

As described above, the text style St is information for generating the text information Tx, that is, information for text conversion of the content according to the input image Pi, and may include information estimated from the content according to the input image Pi.

Further, the text style St may include information indicating a feature of the input image Pi, specifically, information indicating a feature of the subject in the input image Pi. For example, in a case where the subject in the input image Pi includes “dog”, “dog” may be used as the text style St.

Further, a combination of the text styles St exemplified above may be used as the text style St. For example, “onomatopoeia indicating a pleasant atmosphere” obtained by combining “pleasant” as an example of the atmosphere and “onomatopoeia” as an example of the expression technique may be used as the text style St.

As described above, the image processing apparatus according to the present embodiment decides the text style St based on the input image Pi, and generates the text information Tx corresponding to the input image Pi based on the input image Pi and the text style St.

Accordingly, it is possible to assign appropriate text information Tx to the input image Pi.

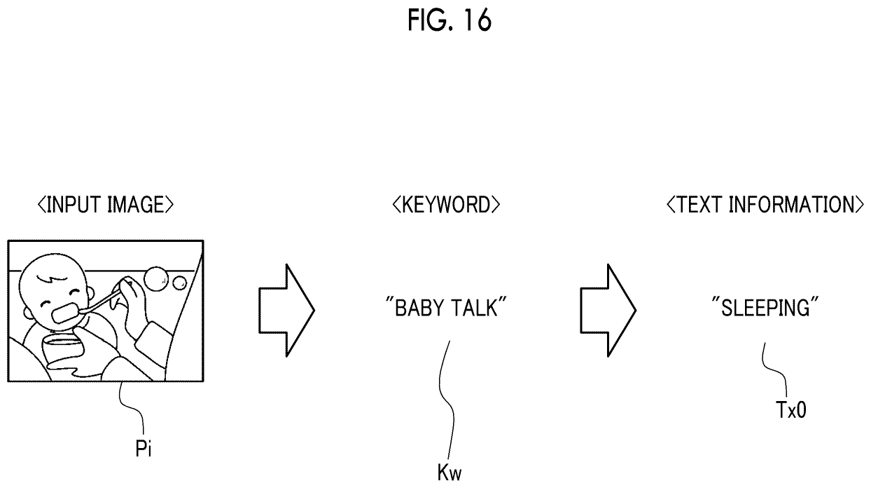

This point will be described in more detail with reference to a comparative example (refer to FIG. 16) showing the related art such as JP2019-149709A. In the image processing apparatus according to the comparative example shown in FIG. 16, the input image Pi is analyzed to extract a keyword Kw, and text information Tx0 corresponding to the keyword Kw is selected with reference to a database (not shown). Therefore, in a case where the keyword Kw is decided, a content of the text information Tx0 is limited to text information determined in advance corresponding to the keyword Kw.

However, even in a case where an appropriate keyword Kw corresponding to the input image Pi is extracted, the text information determined in advance corresponding to the keyword Kw may not correspond to appropriate text information Tx0 corresponding to the input image Pi depending on the input image Pi. In the above case, the appropriate text information Tx0 is not assigned to the input image Pi.

On the contrary, in the image processing apparatus according to the present embodiment, as shown in FIG. 2, the text information Tx is generated based on not only the text style St but also both the input image Pi and the text style St. Therefore, it is possible to assign the appropriate text information Tx to the input image Pi. In particular, in the present embodiment, the text information Tx is generated and is not the predetermined text information. Therefore, it is possible to assign more appropriate text information Tx to the input image Pi.

From the above reason, in the image processing apparatus according to the present embodiment, it is possible to assign the appropriate text information Tx to the input image Pi.

### Configuration Example of Image Processing Apparatus

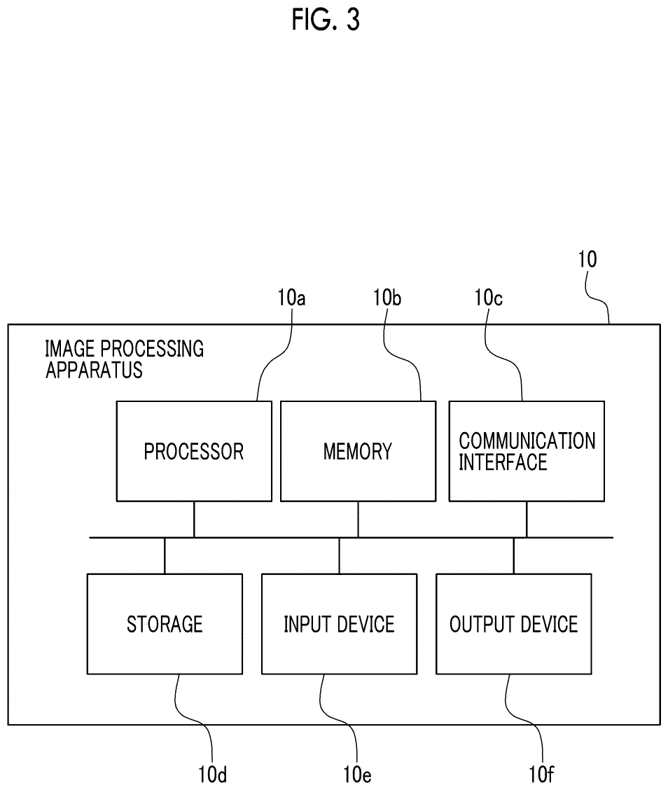

Next, a configuration example of the image processing apparatus (hereinafter image processing apparatus 10) according to the present embodiment will be described with reference to FIG. 3.

The image processing apparatus 10 is configured of a computer used by the user, specifically, a client terminal, and is specifically configured of a smartphone, a tablet terminal, a notebook personal computer (PC), or the like. The image processing apparatus 10 is not limited to the computer owned by the user, and may be configured of a terminal that is not owned by the user, such as a store-installed terminal, which is available by inputting a personal identification number, a password, or the like in a case where the user visits a store or the like, or by making a deposit or the like.

In the following, a case where the image processing apparatus 10 is configured of the computer owned by the user, specifically, the smartphone will be described as an example.

As shown in FIG. 3, the computer constituting the image processing apparatus 10 comprises a processor 10a, a memory 10b, a communication interface 10c, a storage 10d, an input device 10e, and an output device 10f.

The processor 10a is configured of, for example, a central processing unit (CPU), a micro-processing unit (MPU), a micro controller unit (MCU), a graphics processing unit (GPU), a digital signal processor (DSP), a tensor processing unit (TPU), or an application specific integrated circuit (ASIC).

The memory 10b is configured of, for example, a semiconductor memory such as a read only memory (ROM) and a random access memory (RAM).

The communication interface 10c may be configured of, for example, a network interface card or a communication interface board. The computer constituting the image processing apparatus 10 can communicate with other devices connected to the communication network, such as the Internet and a mobile communication line, via the communication interface 10c.

The storage 10d is configured of, for example, a flash memory, a hard disc drive (HDD), a solid state drive (SSD), a flexible disc (FD), a magneto-optical disc (MO disc), a compact disc (CD), a digital versatile disc (DVD), a secure digital card (SD card), a universal serial bus memory (USB memory), or the like.

The storage 10d may be built in a computer main body constituting the image processing apparatus 10, or may be attached to the computer main body in an external form. Alternatively, the storage 10d may be configured of a network attached storage (NAS) or the like. Further, the storage 10d may be an external device that can communicate with one computer constituting the image processing apparatus 10 through the communication network, such as an online storage or a database server.

The input device 10e is a device that receives an input operation of the user, and is configured of, for example, a touch panel or the like. Further, the input device 10e includes the imaging device, such as a smartphone built-in camera, and a microphone for sound collection.

The output device 10f is configured of, for example, a display.

Further, a program for an operating system (OS) and an application program for image processing execution are installed in the computer constituting the image processing apparatus 10 as software. These programs are read out and executed by the processor 10a to cause the computer constituting the image processing apparatus 10 to exert functions thereof and specifically, to execute a series of pieces of processing related to the generation of the text information Tx. The application program for image processing execution may be acquired by being read from a computer-readable recording medium, or may be acquired by being downloaded through a communication network, such as the Internet or an intranet.

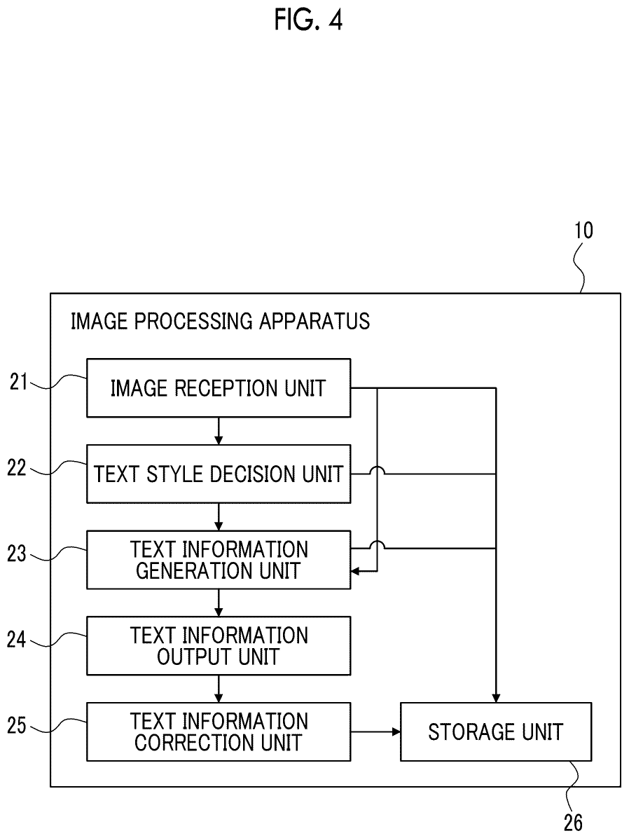

The configuration of the image processing apparatus 10 will be described again from the viewpoint of the function thereof with reference to FIG. 4. As shown in FIG. 4, the image processing apparatus 10 includes an image reception unit 21, a text style decision unit 22, a text information generation unit 23, a text information output unit 24, a text information correction unit 25, and a storage unit 26. These functional units are realized by the processor 10a of the image processing apparatus 10 executing the application program for image processing described above and cooperating with another hardware device of the image processing apparatus 10. Further, some functions may be realized by using artificial intelligence (AI). Hereinafter, each functional unit will be described.

### Image Reception Unit

The image reception unit 21 receives an input of an image to which the text information is to be assigned. As described above, an input method of the image is not particularly limited. For example, the user may capture the subject within an angle of view by using the camera of the smartphone constituting the image processing apparatus 10. In this case, the image reception unit 21 receives an input of image data of a captured image.

### Text Style Decision Unit

The text style decision unit 22 decides the text style St based on the image whose input is received by the image reception unit 21, that is, the input image Pi. Specifically, the text style decision unit 22 analyzes the input image Pi to decide the text style St based on an analysis result thereof.

The “analyzing input image Pi” is, for example, to specify the feature of the image. The “feature of image” is information related to image quality of each region of the image, the gradation value of the pixel included in each region, and information on the subject estimated from these pieces of information. The information on the subject may include a type of the subject, a state of the subject, a position of the subject in the image, and a facial expression in a case where the subject is a person.

Further, it is desirable that the feature of the image can be digitized, vectorized, or tensorized. In this case, the analysis result of the image is the feature of the digitized, vectorized, or tensorized image, that is, a feature amount.

As an example of a decision method of deciding the text style St based on the analysis result of the input image Pi, the text style decision unit 22 may decide the text style St by using a decision model (corresponding to second trained model) trained to output the text style by inputting the input image. The decision model may be constructed, for example, by performing machine learning using an image acquired in the past and the text style associated with the image as learning data.

Accordingly, in the image processing apparatus 10, it is possible to appropriately decide the text style St.

Alternatively, as another example of the decision method of deciding the text style St based on the analysis result of the input image Pi, the text style decision unit 22 may specify the text style St corresponding to the input image Pi, which has been input, with reference to a decision table (corresponding to second table) in which a correspondence relationship between the input image and the text style is set in advance.

Accordingly, in the image processing apparatus 10, it is possible to appropriately decide the text style St.

Further, the text style decision unit 22 may decide the text style St based on a specific subject region extracted by analyzing the input image Pi.

More specifically, in a case where the text style St is decided based on the analysis result of the input image Pi, the text style decision unit 22 may select the specific subject region in the input image Pi as a region-of-interest and decide the text style St by giving priority to the analysis result of the selected region-of-interest over other regions. In the present embodiment, it is assumed that the image processing apparatus 10 automatically selects the region-of-interest.

For example, a region of a main subject in the input image Pi corresponds to “specific subject region”. For example, the main subject corresponds to a subject positioned at a center of the input image Pi, a subject that is in focus, or a subject that occupies a largest area among the subjects in the input image Pi.

Accordingly, in the image processing apparatus 10, the text style St that is interested in the specific subject region is applied. As a result, it is possible to generate the text information Tx that gives priority to the specific subject region.

In the above description, the image processing apparatus 10 automatically selects the region-of-interest, but the present invention is not limited thereto. The region-of-interest may be selected by the user. In this case, the user may select the region-of-interest through the input device 10e. For example, the input image Pi may be displayed on a touch display of the smartphone constituting the image processing apparatus 10, and the user may touch the region-of-interest in the displayed input image Pi.

Accordingly, in the image processing apparatus 10, it is possible to reflect the intention of the user in deciding the text style St.

### Text Information Generation Unit

The text information generation unit 23 generates the text information Tx corresponding to the input image Pi based on the input image Pi and the text style St. Specifically, the text information generation unit 23 generates the text information Tx based on the analysis result of the input image Pi and the decided text style St.

As an example of the method of generating the text information Tx, the text information generation unit 23 may generate the text information Tx by using a generation model (corresponding to first trained model) trained to input the input image and the text style to output the text information. The generation model may be constructed, for example, by performing the machine learning using a combination of the image acquired in the past and the text style and the text information associated with the combination as the learning data.

Accordingly, in the image processing apparatus 10, it is possible to more appropriately generate the text information Tx.

Alternatively, the text information generation unit 23 may specify the text information Tx corresponding to the input image Pi, which has been input, and the text style St with reference to a generation table (corresponding to first table) in which a correspondence relationship between the input image and the text style and the text information is set in advance.

Accordingly, in the image processing apparatus 10, it is possible to more appropriately generate the text information Tx.

### Text Information Output Unit

The text information output unit 24 outputs the text information Tx generated by the text information generation unit 23. The output method of the text information Tx is not particularly limited. For example, the text information Tx may be displayed on a screen of a display (output device 10f) of the computer constituting the image processing apparatus 10 as shown in FIG. 5.

### Text Information Correction Unit

In a case where input information (corresponding to third input information) related to the correction of the text information Tx is received, the text information correction unit 25 corrects the text information Tx based on the input information. For example, as shown in FIG. 5, in a case where the user clicks a “correction” icon displayed on the screen, the text information correction unit 25 enables editing of the text information Tx displayed in the field of the text information on the screen. Thereafter, in a case where the user clicks a “decision” icon displayed on the screen, the text information correction unit 25 corrects the text information Tx based on the input information related to the correction by the user.

As described above, in the image processing apparatus 10, it is possible to reflect the intention of the user in generating the text information Tx.

### Storage Unit

The storage unit 26 stores at least one of the decided text style St or the generated text information Tx as corresponding accessory information of the input image Pi. The input image Pi and the accessory information may be stored in, for example, the storage 10d of the image processing apparatus 10, or may be stored in a storage of a computer that can be indirectly used by the user, for example, a server computer that can communicate with the image processing apparatus 10.

Further, the accessory information may include the text information Tx corrected by the text information correction unit 25.

The input image Pi and the above accessory information may be stored together as the same data file or may be stored as separate data files. In a case where the input image Pi and the accessory information are stored as the separate data files, path information to the other data file may be stored in one data file. Further, a management database that manages the association between both data files may be provided. The management database may show, for example, an association between an identification ID of the data file of the input image Pi and an identification ID of the data file of each piece of the accessory information.

Accordingly, in the image processing apparatus 10, it is possible to organize each piece of information of the input image Pi, the text style St, and the text information Tx in association with each other.

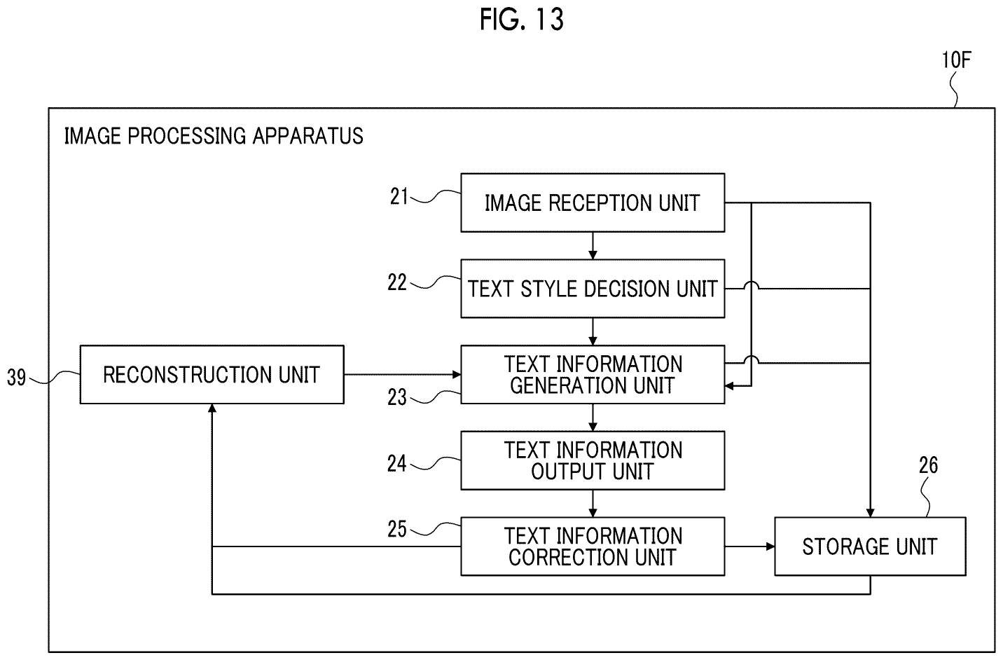

Further, in the image processing apparatus 10, with the storing of each piece of information of the text style St and the text information Tx, it is possible to use each piece of information thereof for future image processing by the image processing apparatus 10. For example, as in a sixth modification example of the present invention described below (refer to FIG. 13), it is possible to use each piece of information described above in a case where the generation model, the generation table, and the like are updated.

### Example of Image Processing Method According to Present Embodiment

Next, as an operation example of the image processing apparatus 10 according to the present embodiment, an image processing flow using the same device will be described. In the image processing flow described below, an image processing method according to the embodiment of the present invention is used. That is, each step in the image processing flow described below corresponds to a component of the image processing method according to the embodiment of the present invention.

The following flow is merely an example. Some steps in the flow may be deleted, a new step may be added to the flow, or an execution order of two steps in the flow may be exchanged, within a range not departing from the spirit of the present invention.

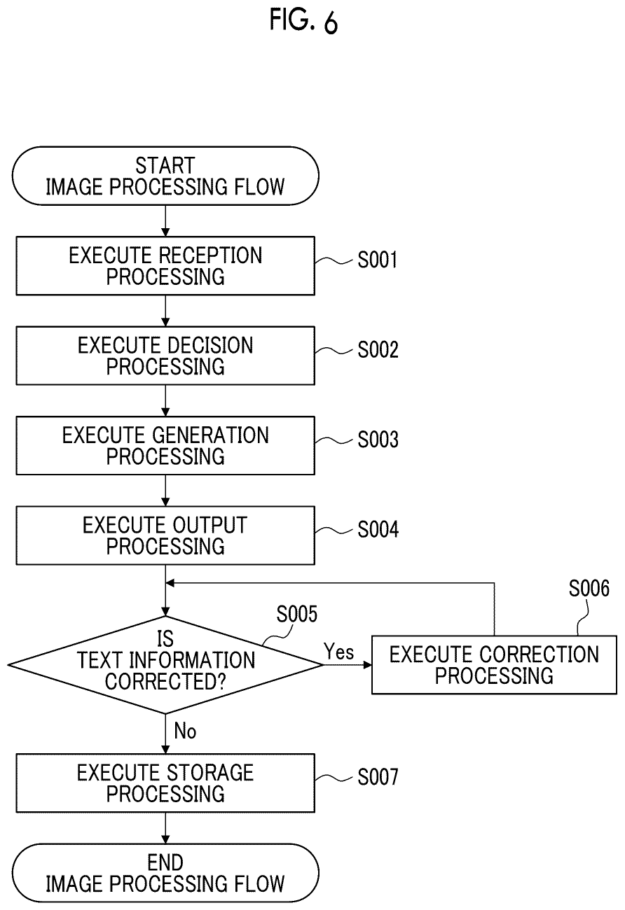

Each step in the image processing flow according to the present embodiment is implemented by the processor 10a provided in the image processing apparatus 10 in an order shown in FIG. 6. That is, in each step in the image processing flow, the processor 10a executes processing corresponding to each step in FIG. 6 among data processing defined in the application program for image processing.

Specifically, in the image processing flow according to the present embodiment, first, the processor 10a executes reception processing (S001). In the reception processing, the processor 10a receives the input of the image to which the text information Tx is to be assigned by the present flow, in other words, acquires the input image Pi to be processed.

Next, the processor 10a executes decision processing of deciding the text style St based on the input image Pi (S002).

Next, the processor 10a executes generation processing of generating the text information Tx corresponding to the input image Pi based on the input image Pi and the text style St (S003).

Next, the processor 10a executes output processing of outputting the generated text information Tx to the user (S004). For example, the processor 10a presents the text information Tx to the user through the screen shown in FIG. 5. Next, the processor 10a executes determination processing of determining whether or not the input information related to the correction of the text information Tx is received (S005). In a case where the input information related to the correction of the text information Tx is received, the processor 10a executes correction processing of correcting the text information Tx based on the input information (S006).

In a case where the input information related to the correction of the text information Tx is not received, the processor 10a executes storage processing of storing at least one of the decided text style St or the generated text information Tx as the corresponding accessory information of the input image Pi (S007).

The image processing flow according to the present embodiment ends at a point in time at which the series of pieces of processing described above ends. In a case where the input image Pi is received, the image processing flow is implemented each time the input image Pi is received. That is, the series of pieces of processing described above is repeatedly executed by the processor 10a each time a new input image Pi is received.

### Other Embodiments

Although the specific embodiment of the present invention has been described above, the above embodiment is merely an example for ease of understanding of the present invention, and is not intended to limit the present invention. That is, the present invention may be changed or improved from the embodiment described below without departing from the spirit of the present invention. Further, the present invention also includes equivalents thereof.

Hereinafter, modification examples thereof will be described. In the following, differences between the modification examples and the above embodiments will be described.

### About First Modification Example

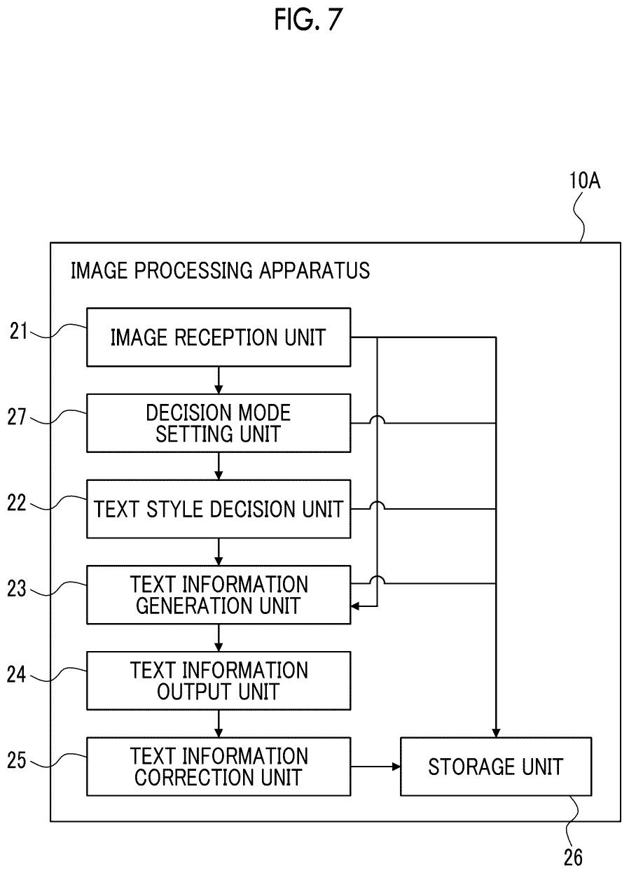

In the above embodiment, the image processing apparatus 10 decides the text style St based on the input image Pi. However, the present invention is not limited thereto. As in an image processing apparatus 10A shown in FIG. 7, the text style St may be decided based on the input information (corresponding to first input information) related to the text style St.

More specifically, the image processing apparatus 10A may further include a decision mode setting unit 27 as the functional unit, in contrast to the image processing apparatus 10. The decision mode setting unit 27 sets a first decision mode in which the text style St is decided based on the input image Pi or a second decision mode in which the text style St is decided based on the input information related to the text style St. More specifically, the decision mode setting unit 27 sets one of the first decision mode or the second decision mode in response to an instruction of the user to set the decision mode.

Next, in a case where the decision mode setting unit 27 sets the first decision mode, the text style decision unit 22 decides the text style St based on the input image Pi as in the above embodiment. On the other hand, in a case where the decision mode setting unit 27 sets the second decision mode, the text style decision unit 22 decides the text style St based on the input information related to the text style St. The input information related to the text style St corresponds to, for example, the information such as the atmosphere, the writing style, the language system, the expression technique, the font, and the decoration exemplified above. For example, the user inputs, to the image processing apparatus 10, “pleasant” or the like indicating the atmosphere of the text information Tx, as the input information related to the text style St, through the input device 10e. Accordingly, the text style decision unit 22 decides the text style St based on the input information related to the input text style St.

As described above, in the image processing apparatus 10A, it is possible to reflect the intention of the user in deciding the text style St.

The input information related to the text style St is not limited to the input information from the user. For example, the decision mode setting unit 27 may decide the text style St based on the input information related to the text style St from an external information processing apparatus or the like, which is different from the image processing apparatus 10A.

Description will be made in more detail using one example. A case is assumed in which a character image (for example, image indicating message) indicating the character information, which is different from the text information Tx, is disposed on a cover, a margin of each page, and the like of a photo book configured of a plurality of images including the input image Pi. In this case, the external information processing apparatus may analyze the character image to acquire the input information (for example, “pleasant” described above) related to the text style St.

As described above, the text style decision unit 22 may decide the text style St based on the input information related to the text style St acquired from the external information processing apparatus or the like.

### About Second Modification Example

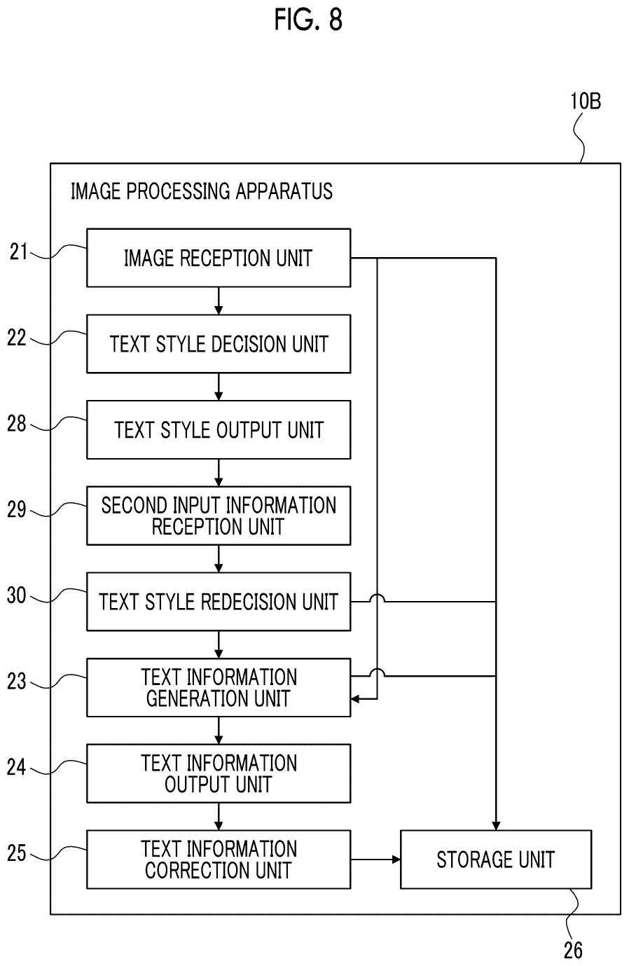

In the above embodiment, the text information Tx is generated based on the text style St first decided based on the input image Pi. However, the present invention is not limited thereto. As in an image processing apparatus 10B shown in FIG. 8, the text information Tx may be generated based on the text style St decided again.

More specifically, the image processing apparatus 10B may further include a text style output unit 28, a second input information reception unit 29, and a text style redecision unit 30 as the functional unit, in contrast to the image processing apparatus 10.

The text style output unit 28 outputs the text style St decided by the text style decision unit 22, specifically, displays the text style St on the screen of the output device 10f. In a case where the text style St displayed on the screen is changed, the user inputs the input information (corresponding to second input information) related to the text style St. Accordingly, the second input information reception unit 29 receives the input information related to the text style St. The text style redecision unit 30 decides the text style again based on the received input information related to the text style St. Thereafter, the text information generation unit 23 generates the text information Tx based on the input image Pi and the text style St decided again.

As described above, in the image processing apparatus 10B, in a case where the user checks the text style St initially decided based on the input image Pi and determines that the text style St needs to be changed, it is possible to decide the text style St again. Accordingly, it is possible to reflect the intention of the user in deciding the text style St.

### About Third Modification Example

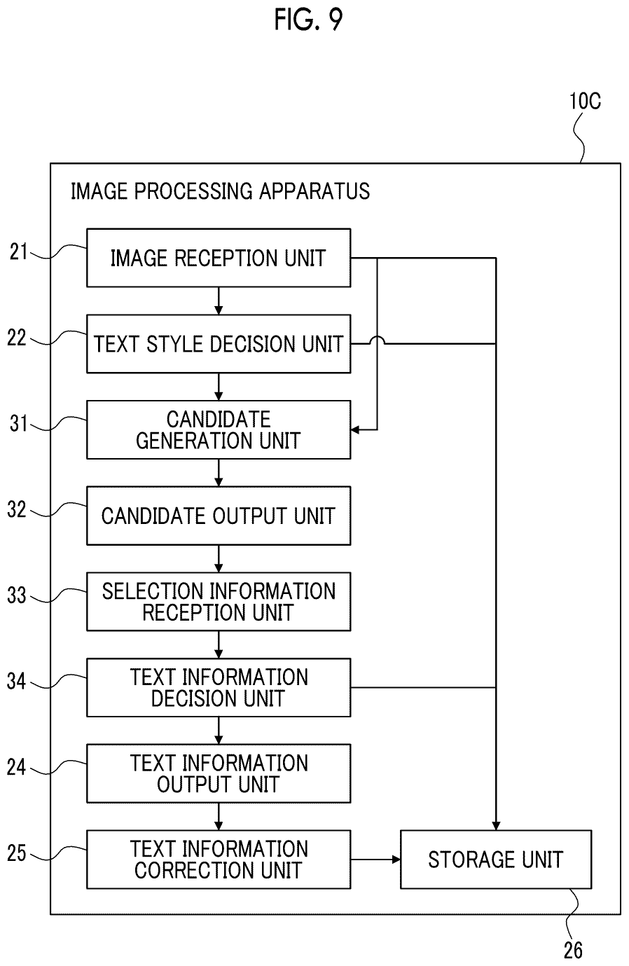

In the above embodiment, one piece of text information Tx is generated. However, the present invention is not limited thereto. As in an image processing apparatus 10C shown in FIG. 9, two or more candidates for the text information Tx may be generated, and one piece of text information Tx to be assigned to the input image Pi may be decided from the generated two or more pieces of text information Tx.

More specifically, the image processing apparatus 10C may further include a candidate generation unit 31, a candidate output unit 32, a selection information reception unit 33, and a text information decision unit 34 as the functional unit, in contrast to the image processing apparatus 10.

The candidate generation unit 31 generates the two or more candidates for the text information Tx based on the input image Pi and the text style St. More specifically, first, the text style decision unit 22 decides two or more text styles St based on the input image Pi. The candidate generation unit 31 generates the two or more candidates for the text information Tx based on a combination of the input image Pi and each of the two or more text styles St.

The candidate output unit 32 outputs the generated two or more candidates for the text information Tx, and for example, displays the two or more candidates for the text information Tx on the screen of the output device 10f. The user selects a desired piece of text information Tx from the two or more candidates for the text information Tx displayed on the screen. Accordingly, the selection information reception unit 33 receives the text information Tx selected by the user as selection information. The text information decision unit 34 decides the text information Tx from the two or more candidates for the text information Tx based on the received selection information.

As described above, in the image processing apparatus 10C, the user can select the text information Tx from the candidates for the text information Tx. Therefore, it is possible to reflect the intention of the user in generating the text information Tx.

### About Fourth Modification Example

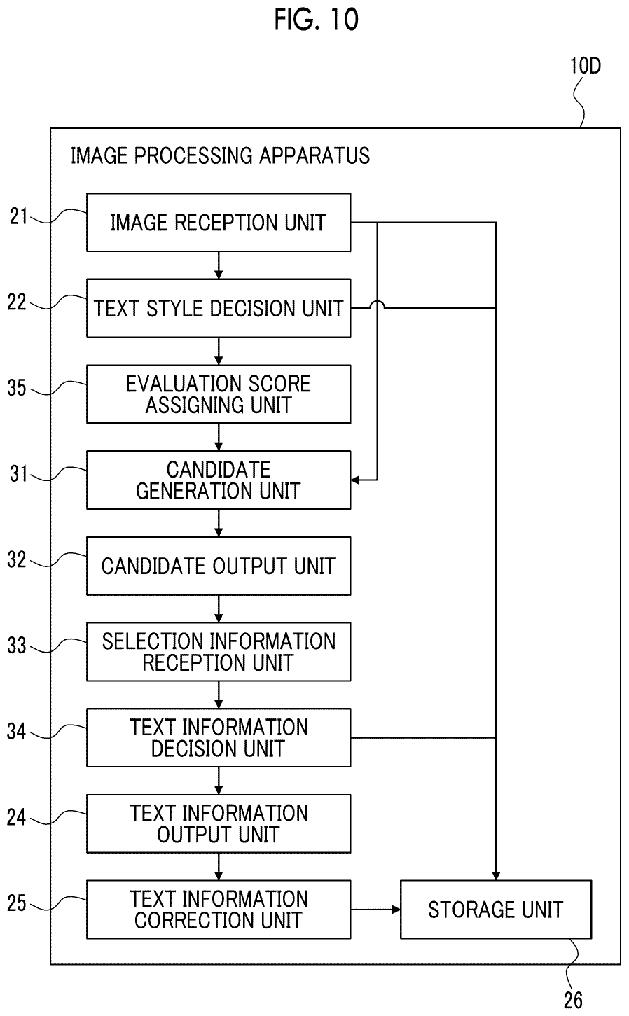

Further, a functional unit may be further added to the image processing apparatus 10C as an image processing apparatus 10D shown in FIG. 10. The image processing apparatus 10D may further include an evaluation score assigning unit 35, in addition to the functional unit of the image processing apparatus 10C.

Specifically, first, the text style decision unit 22 decides two or more text styles St based on the input image Pi, in the same manner as in the third modification example described above. Next, the evaluation score assigning unit 35 assigns an evaluation score according to a correlation with a content of the input image Pi to each of the decided two or more text styles St. For the evaluation score according to the correlation, for example, a higher evaluation score may be assigned to the text style St that is more limited or more specifically described. For example, as the evaluation score of the text style St, a high evaluation score may be assigned to “colloquial style popular with teenagers”, which is more limited information than “colloquial style” exemplified in the above description.

The evaluation score assigning unit 35 assigns the evaluation score for each text style St, and then the candidate generation unit 31 generates the text information Tx for each text style St to which the evaluation score is assigned, based on the input image Pi and the text style St.

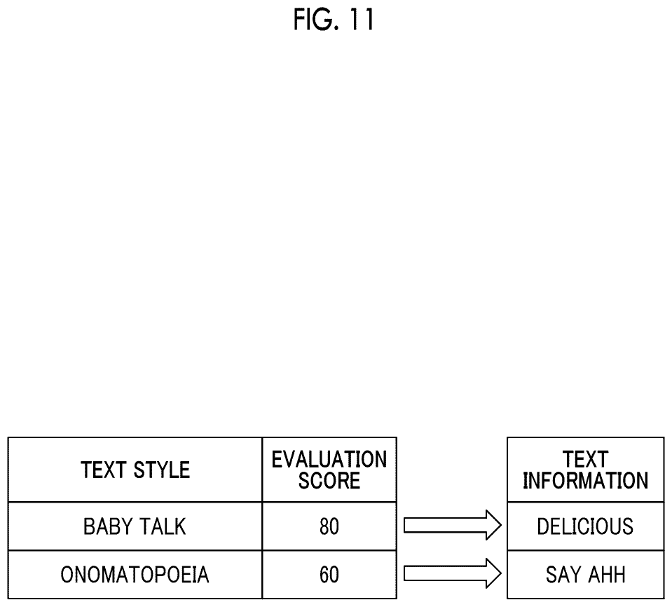

Thereafter, the candidate output unit 32 outputs the generated two or more pieces of text information Tx, based on the evaluation score of the text style St. More specifically, as in the example shown in FIG. 11, the text information Tx “delicious” is displayed on the screen in association with an evaluation score “80” of the corresponding text style St “baby talk”. Further, text information Tx “say ahh” is displayed on the screen in association with an evaluation score “60” of a corresponding text style St “onomatopoeia”. The two or more candidates for the text information Tx may be displayed in descending order or ascending order of the evaluation scores of the text styles St.

The user selects a desired piece of text information Tx from the two or more candidates for the text information Tx displayed on the screen while referring to the evaluation score of the text style St. The selection information reception unit 33 receives the text information Tx selected by the user as the selection information. The text information decision unit 34 decides the text information Tx from the two or more candidates for the text information Tx based on the received selection information by the user.

As described above, in the image processing apparatus 10D, the user can reflect the intention of the user in generating the text information Tx while referring to the evaluation score of the text style St by the image processing apparatus 10D.

### About Fifth Modification Example

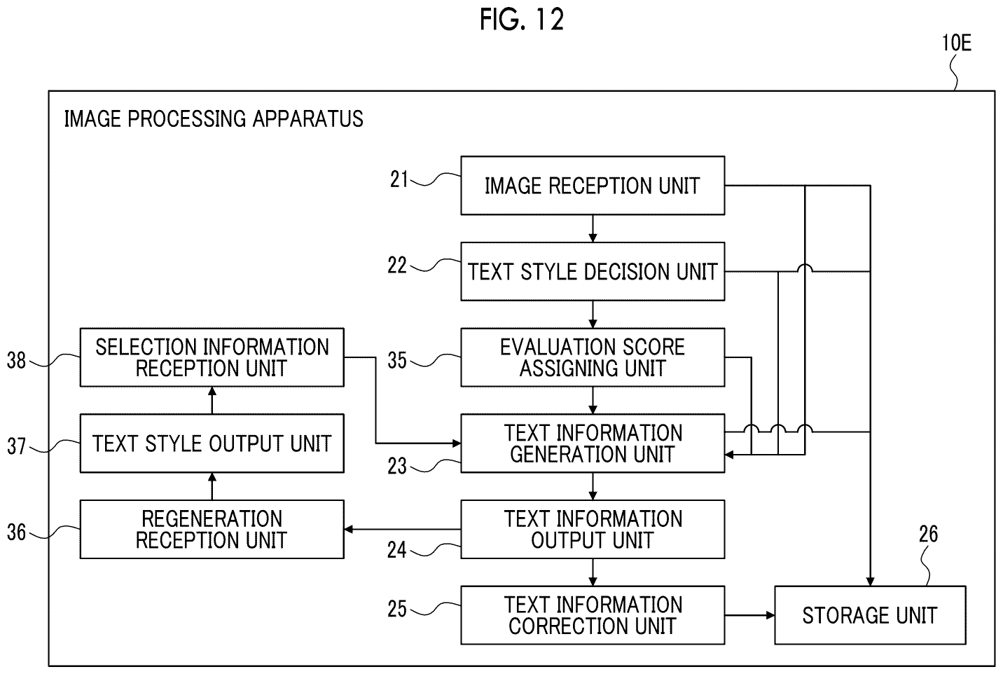

Further, as shown in FIG. 12, an image processing apparatus 10E may further include a regeneration reception unit 36, a text style output unit 37, and a selection information reception unit 38 in addition to the evaluation score assigning unit 35, as the functional unit, in contrast to the image processing apparatus 10.

More specifically, first, the text style decision unit 22 decides two or more text styles St based on the input image Pi. Next, the evaluation score assigning unit 35 assigns the evaluation score according to a correlation with a content of the input image Pi to each of the decided two or more text styles St.

Thereafter, the text information generation unit 23 generates the text information Tx based on the input image Pi and the text style St having a highest evaluation score among the two or more text styles St. More specifically, as shown in FIG. 11, in a case where the text style St having the highest evaluation score among the two or more text styles St is “baby talk”, “delicious” as the text information Tx is generated based on the input image Pi and the “baby talk” as the text style St. The text information output unit 24 outputs this text information Tx to, for example, the screen of the output device 10f.

In a case where the user requests the regeneration of the text information Tx through the input device 10e, the regeneration reception unit 36 receives the request for the regeneration of the text information Tx. Accordingly, the text style output unit 37 outputs the text style St different from the text style St having the highest evaluation score. More specifically, as shown in FIG. 11, the text style output unit 37 outputs, to the screen of the output device 10f, the “onomatopoeia” as the text style St different from the text style St having the highest evaluation score.

In a case where the user selects a desired text style St from the output one or more text styles St, the selection information reception unit 38 receives the input information related to the text style St selected by the user as the selection information. Thereafter, the text information generation unit 23 generates the text information Tx again based on the input image Pi and the text style St selected by the user. In the example shown in FIG. 11, in a case where the user selects the text style St “onomatopoeia”, the text information Tx “say ahh” is generated again.

As described above, in the image processing apparatus 10E, it is possible to preferentially generate the text information Tx based on the text style St having the highest evaluation score. On the other hand, it is possible to generate the text information Tx based on the text style St different from the text style St having the highest evaluation score in accordance with the intention of the user.

### About Sixth Modification Example

Further, as shown in FIG. 13, an image processing apparatus 10F may further include a reconstruction unit 39 as the functional unit, in contrast to the image processing apparatus 10. Examples of functions of the reconstruction unit 39 include the following two examples.

As a first example, the reconstruction unit 39 may reconstruct the generation model used in the text information generation unit 23. As described above, the generation model is constructed by performing the machine learning using the learning data including the input image, the text style, and the text information. As shown in FIG. 13, the reconstruction unit 39 acquires corrected text information Tx from at least one of the text information correction unit 25 or the storage unit 26. The reconstruction unit 39 reconstructs the generation model using the learning data including the corrected text information Tx. The term “reconstructing” means to execute relearning to update an already constructed trained model, more specifically, to update a parameter, a coefficient, and the like of the trained model.

As a second example, the reconstruction unit 39 may correct the generation table used in the text information generation unit 23. As described above, the generation table is a table in which the correspondence relationship between the input image and the text style and the text information is set in advance. As shown in FIG. 13, the reconstruction unit 39 acquires corrected text information Tx from at least one of the text information correction unit 25 or the storage unit 26. The reconstruction unit 39 corrects the generation table by using the corrected text information Tx.

As described above, in the image processing apparatus 10F, it is possible to reconstruct at least one of the generation model or the generation table. As a result, it is possible to assign more appropriate text information Tx.

### About Seventh Modification Example

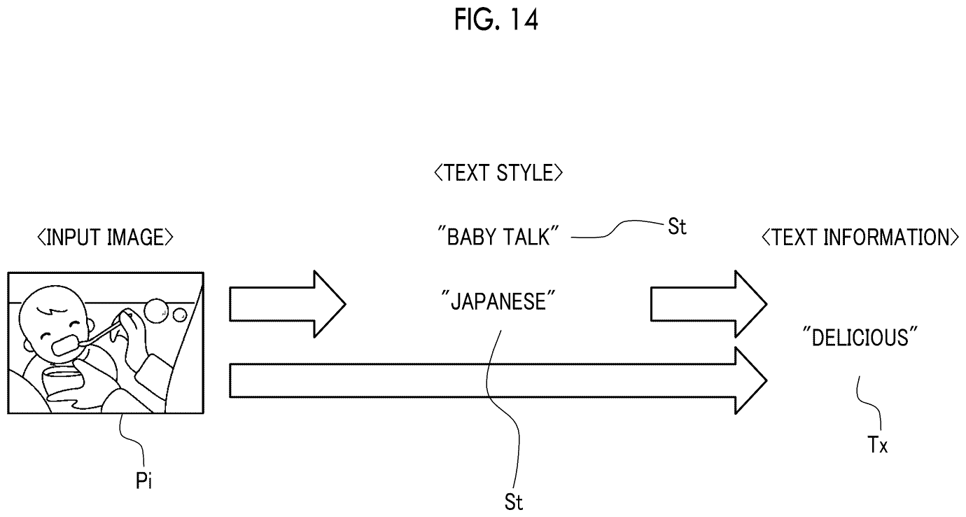

Further, in the above embodiment, one piece of text information Tx is generated based on one text style St, but the present invention is not limited thereto. As shown in FIG. 14, one or more pieces of text information Tx may be generated based on two or more text styles St.

In this case, the text style decision unit 22 may decide the two or more text styles St based on the input image Pi, and the text information generation unit 23 may generate the one or more pieces of text information Tx based on the two or more text styles St.

The two or more text styles St may be two or more text styles St having different themes. That is, the text style decision unit 22 may decide the two or more text styles St having different themes based on the input image Pi, and the text information generation unit 23 may generate, according to a combination of the two or more text styles St having different themes, the text information Tx for each combination.

The themes of the text style St may be classified based on, for example, the information such as the atmosphere, the writing style, the language system, the expression technique, the font, and the decoration described above. Further, each of the classified themes may be further classified in more detail.

As an example of a method of deciding the text style St, the method of using one decision model is described, but for example, a plurality of decision models may be used. That is, the text style decision unit 22 may decide the text style St output from each of the plurality of decision models as the two or more text styles St.

Alternatively, the text style decision unit 22 may use the plurality of decision models constructed for each theme of the text style St. In this case, the text style decision unit 22 may decide the text styles St having different themes from each other, which are output from the plurality of decision models, as the two or more text styles St.

As described above, in the image processing apparatus according to the seventh modification example, with the use of the plurality of text styles St, it is possible to generate more appropriate text information Tx. In particular, with the use of the text styles St having different themes, the text information Tx is generated based on a plurality of viewpoints. Accordingly, it is possible to assign more appropriate text information Tx to the input image Pi. About eighth modification example

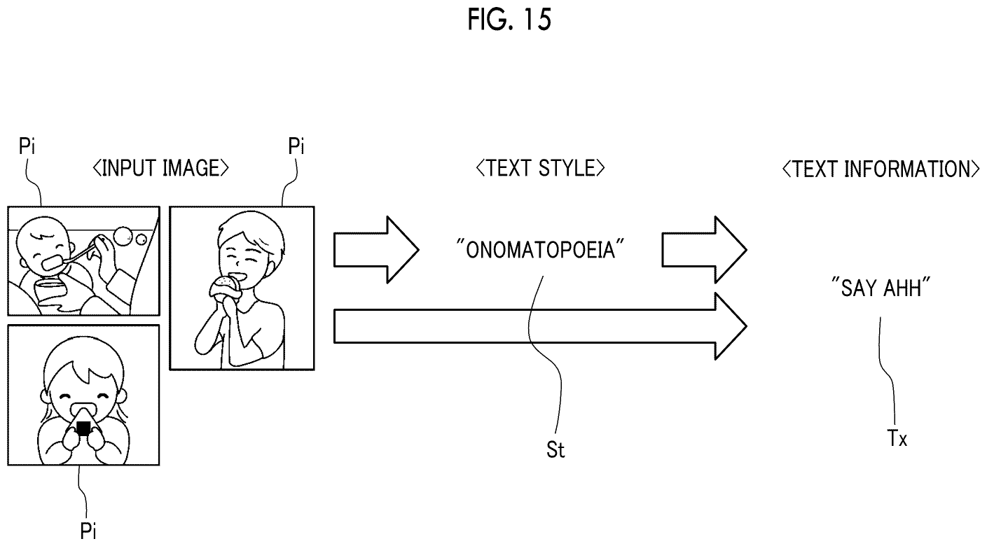

Further, in the above embodiment, one input image Pi is input (acquired), but the present invention is not limited thereto. For example, a plurality of input images Pi may be input as shown in FIG. 15.

In this case, first, the image reception unit 21 acquires the plurality of input images Pi.

Next, the text style decision unit 22 decides the text style St common to the plurality of acquired input images Pi. More specifically, the image reception unit 21 analyzes each of the plurality of input images Pi and decides one text style St for the plurality of input images Pi based on an analysis result of each input image Pi. That is, the decision of the common text style St means to decide one text style St for the plurality of input images Pi.

Next, the text information generation unit 23 generates the text information Tx common to each of the plurality of input images Pi, based on the plurality of input images Pi and the common text style St. The generation of the common text information Tx means to generate one piece of text information Tx for the plurality of input images Pi.

As described above, in the image processing apparatus according to the eighth modification example, it is possible to generate one piece of common text information Tx for the plurality of input images Pi. Accordingly, for example, as a title on a page of the photo book, it is possible to generate the text information Tx common to the plurality of input images Pi disposed on the page. In the image processing apparatus according to the eighth modification example, for example, as the title for each page of the photo book, the text information Tx may be generated for each of the plurality of input images Pi disposed on the page while generating the common text information Tx.

### About Computer Constituting Image Processing Apparatus

In the above embodiment, the image processing apparatus according to the embodiment of the present invention is configured by a computer that is directly used by the user, such as a terminal (client terminal) owned by the user. However, the present invention is not limited thereto. The image processing apparatus according to the embodiment of the present invention may be configured of a computer that can be indirectly used by the user, for example, a server computer. The server computer may be, for example, a server computer for a cloud service, specifically, a server computer for an application service provider (ASP), software as a service (SaaS), platform as a service (PaaS), or infrastructure as a service (IaaS). In this case, in a case where necessary information is input to the client terminal, the server computer performs various types of processing (calculation) based on the input information, and a calculation result is output to a client terminal side. That is, it is possible to use the function of the server computer constituting the image processing apparatus according to the embodiment of the present invention on the client terminal side.

### About Configuration of Processor

The processor provided in the image processing apparatus according to the embodiment of the present invention includes various processors. Examples of the various processors include a CPU that is a general-purpose processor that executes software (program) and functions as various processing units.

Moreover, various processors include a programmable logic device (PLD), which is a processor of which a circuit configuration can be changed after manufacturing, such as a field programmable gate array (FPGA).

Furthermore, the various processors include a dedicated electric circuit that is a processor having a circuit configuration specially designed for executing a specific process, such as an application specific integrated circuit (ASIC).

Further, one functional unit of the image processing apparatus according to the embodiment of the present invention may be configured of one of the various processors described above. Alternatively, one functional unit of the image processing apparatus according to the embodiment of the present invention may be configured of a combination of two or more processors of the same type or different types, for example, a combination of a plurality of FPGAs or a combination of an FPGA and a CPU.

Further, a plurality of functional units of the image processing apparatus according to the embodiment of the present invention may be configured of one of the various processors, or two or more of the plurality of functional units may be configured of one processor.

Further, as in the above embodiment, a form may be employed in which one processor is configured of a combination of one or more CPUs and software, and the processor functions as the plurality of functional units.

Further, for example, as represented by a system on chip (SoC) or the like, a form may be employed in which a processor that realizes the functions of the entire system including the plurality of functional units in the image processing apparatus according to the embodiment of the present invention with one integrated circuit (IC) chip is used. Further, a hardware configuration of the various processors described above may be an electric circuit (circuitry) in which circuit elements, such as semiconductor elements, are combined.

### EXPLANATION OF REFERENCES

10, 10A, 10B, 10C, 10D, 10E, 10F: image processing apparatus
10a: processor
10b: memory
10c: communication interface
10d: storage
10e: input device
10f: output device
21: image reception unit
22: text style decision unit
23: text information generation unit
24: text information output unit
25: text information correction unit
26: storage unit
27: first input information reception unit
28, 37: text style output unit
29: second input information reception unit
30: text style redecision unit
31: candidate generation unit
32: candidate output unit
33, 38: selection information reception unit
34: text information decision unit
35: evaluation score assigning unit
36: regeneration reception unit
39: reconstruction unit
Kw: keyword
Pi: input image
St: text style
Tx, Tx0: text information

What is claimed is:

1. An image processing apparatus comprising a processor,
wherein the processor is configured to:
decide a text style based on an image; and
generate text information corresponding to the image based on the image and the text style.

2. The image processing apparatus according to claim 1,
wherein the processor is configured to:
set a first decision mode in which the text style is decided based on the image or a second decision mode in which the text style is decided based on first input information; and
decide the text style based on the set first decision mode or second decision mode.

3. The image processing apparatus according to claim 2,
wherein the processor is configured to:
decide, in a case where the second decision mode is set, the text style based on the first input information from a user related to the text style.

4. The image processing apparatus according to claim 1,
wherein the processor is configured to:
output the decided text style;
decide the text style again based on second input information related to the text style; and
generate the text information based on the image and the text style decided again.

5. The image processing apparatus according to claim 1,
wherein the processor is configured to:
decide the text style based on a specific subject region extracted by analyzing the image.

6. The image processing apparatus according to claim 1,
wherein the processor is configured to:
decide two or more text styles based on the image; and
generate the text information based on the two or more text styles.

7. The image processing apparatus according to claim 6,
wherein the processor is configured to:
decide the two or more text styles having different themes based on the image; and
generate, according to a combination of the two or more text styles having different themes, the text information for each combination.

8. The image processing apparatus according to claim 1,
wherein the processor is configured to:
use a first trained model trained to output the text information by inputting the image and the text style to generate the text information.

9. The image processing apparatus according to claim 1,
wherein the processor is configured to:
specify the text information corresponding to the input image and text style with reference to a first table in which a correspondence relationship between the image and the text style and the text information is set in advance.

10. The image processing apparatus according to claim 1,
wherein the processor is configured to:
use a second trained model trained to output the text style by inputting the image to decide the text style.

11. The image processing apparatus according to claim 1,
wherein the processor is configured to:
specify the text style corresponding to the input image with reference to a second table in which a correspondence relationship between the image and the text style is set in advance.

12. The image processing apparatus according to claim 1,
wherein the processor is configured to:
generate two or more candidates for the text information based on the image and the text style;
output the generated two or more candidates for the text information; and
decide the text information from the two or more candidates for the text information based on selection information by a user.

13. The image processing apparatus according to claim 1,
wherein the processor is configured to:
decide two or more text styles based on the image;
assign an evaluation score according to a correlation with a content of the image to each of the two or more text styles;
generate the text information for each text style to which the evaluation score is assigned based on the image and the text style; and
output the generated two or more pieces of text information based on the evaluation score of the text style.

14. The image processing apparatus according to claim 1,
wherein the processor is configured to:
decide two or more text styles based on the image;
assign an evaluation score according to a correlation with a content of the image to each of the two or more text styles;
generate the text information based on the image and the text style having a highest evaluation score among the two or more text styles;
output the generated text information;
output, in a case where a request for generating the text information again is received, the text style different from the text style having the highest evaluation score; and
generate the text information again based on the image and the text style selected by a user.

15. The image processing apparatus according to claim 1,
wherein the processor is configured to:
output the generated text information; and
correct, in a case where third input information related to correction of the text information is received, the text information based on the third input information.

16. The image processing apparatus according to claim 15,
wherein the processor is configured to:
reconstruct a first trained model constructed by performing machine learning using learning data including an image, a text style, and text information, using the learning data including the corrected text information.

17. The image processing apparatus according to claim 15,
wherein the processor is configured to:
correct a first table in which a correspondence relationship between the image and the text style and the text information is set in advance, using the corrected text information.

18. The image processing apparatus according to claim 1,
wherein the processor is configured to:
acquire a plurality of the images;
decide the text style common to the acquired plurality of images; and
generate the text information common to each of the plurality of images based on the plurality of images and the common text style.

19. The image processing apparatus according to claim 1,
wherein the processor is configured to:
store at least one of the decided text style or the generated text information as corresponding accessory information of the image.

20. An image processing method executed by a processor, comprising:
processing of deciding a text style based on an image; and
processing of generating text information corresponding to the image based on the image and the text style.

21. A computer-readable recording medium on which a program for causing a computer to execute each piece of processing included in the image processing method according to claim 20 is recorded.
